(19) United States
(12) Patent Application Publication
(10) Pub. No.: US 2019/0183605 A1
(43) Pub. Date: Jun. 20, 2019

(54) AIR INJECTION DEVICE AND DENTAL HANDPIECE SYSTEM

(71) Applicants: Osamu MOTOYAMA, Tokyo (JP); GC CORPORATION, Sunto-gun, Shizuoka (JP)

(72) Inventors: Osamu MOTOYAMA, Tokyo (JP); Ryouji KINAMI, Tokyo (JP); Shunjirou KUME, Tokyo (JP); Takahiro UENOYAMA, Tokyo (JP)

(73) Assignees: GC CORPORATION, Sunto-gun, Shizuoka (JP); Osamu MOTOYAMA, Tokyo (JP)

(21) Appl. No.: 16/331,001

(22) PCT Filed: Jul. 18, 2017
(86) PCT No.: PCT/JP2017/025858

§ 371 Date: Mar. 6, 2019

(30) Foreign Application Priority Data
Sep. 29, 2016 (JP) 2016-191151

(51) Int. Cl. A61C 1/08; A61C 17/02; A61C 19/00

(52) U.S. Cl. CPC A61C 1/08; A61C 1/0007; A61C 19/00; A61C 17/0202

(57) ABSTRACT

To provide an air injection device for a dental handpiece which makes it possible to obtain a clear image even if the position of an image taking part is changed, provided is an air injection device including: a trunk connector (41) that is in a form of a column, in the trunk connector a passage being formed; an air guiding pipe (45) that is in a form of a pipe, one end of the air guiding pipe being connected to the trunk connector, the air guiding pipe having flexibility; and a means (46) that retains the air guiding pipe in the dental handpiece main body, wherein the passage in the trunk connector branches, one of the branching passages communicating with the air guiding pipedental handpiece.

### TECHNICAL FIELD

The present invention relates to an air injection device for a dental handpiece, and a dental handpiece system which are used in dental treatment.

### BACKGROUND ART

In dental treatment, a dental handpiece main body is equipped with a tool, and teeth are drilled by means of this tool. At this time, a practitioner preferably proceeds with drilling while observing a drilling state. Specifically, it is known that it is important for a shape of a dental prosthesis mounted on a tooth to accurately correspond to that of a drilled tooth, and that this accuracy strongly influences a lifetime of a dental prosthesis. Therefore, it is very important to precisely perform drilling while observing a drilling state more clearly.

A method of visually observing teeth directly, and a method of using a mirror are included in methods for observing a state of teeth in the performance. However, visual observation gives rise to a blind spot, and a mirror is difficult to be used together with a dental handpiece.

For this, Patent Literature 1 discloses the technique of providing parts for taking in images in such a way that the parts are aligned on a tool mounted part of a dental handpiece, and from these parts, taking in images using a camera via optical fiber, to display the images. It is described that according to this, teeth to be drilled can be shown on a display, which makes it possible to perform drilling while observing a drilled portion.

However, while a dental handpiece device on which such an imaging means is mounted has a function of treating an affected part and a function of observing an affected part and its peripheral region using an image, swarf produced by a drilling tool, and spray by pressurized water for cooling which is injected from a head part of a handpiece attach to a window for taking in an image which is provided around a tool mounted part, to suppress the observation function, which is problematic.

For this, Patent Literature 2 discloses the structure of injecting an air flow into a range of a region between an imaging window of a camera and a portion drilled with a drilling tool or of injecting an air flow toward the imaging window, using an air passage that branches from a compressed air passage inside a handpiece, to prevent the imaging window from fogging because of swarf and water droplets.

### CITATION LIST

### Patent Literature

Patent Literature 1: JP H9-56730 A

Patent Literature 2: JP 2015-29694 A

### SUMMARY OF INVENTION

### Technical Problem

However, the function of preventing the imaging window of the camera from fogging using the branch of the compressed air passage in the technique of Patent Literature 2 is based on the structure of having a built-in camera module in a handpiece, where the position of the imaging window is fixed. Therefore, when (an) image taking part(s) of a camera module is/are mounted in one or plural places on a handpiece main body via a retention member so that (a) position(s) thereof can be changed around a tool mounted part, it is difficult to make an air flow follow the camera module when the position(s) of the image taking part(s) of the camera module is/are changed, which makes proper photographing impossible.

In view of the above described problem, an object of the present invention is to provide an air injection device for a dental handpiece which makes it possible to obtain a clear image even if the position of an image taking part is changed. A dental handpiece system that includes this air injection device is also provided.

### Solution to Problem

Hereinafter the present invention will be described. Here, reference numerals in the drawings are also provided in parentheses for easy understanding. However, the present invention is not limited thereto.

One aspect of the present invention is an air injection device (40) that is provided for a dental handpiece main body (1), the air injection device comprising: a trunk connector (41) that is in a form of a column, in the trunk connector a passage being formed; an air guiding pipe (45) that is in a form of a pipe, one end of the air guiding pipe being connected to the trunk connector, the air guiding pipe having flexibility; and a means (46) that retains the air guiding pipe in the dental handpiece main body, wherein the passage in the trunk connector branches, one of the branching passages communicating with the air guiding pipe.

Another aspect of the present invention is a dental handpiece system (100) comprising: a dental handpiece main body (1); an image obtaining device (11) that is capable of taking an image of a drilling part of a tool (3) that is provided for the dental handpiece main body; and the air injection device (40).

At this time, the air guiding pipe (45) is disposed in such a way as to inject air into a range where the image obtaining device (11) takes the image.

A position where the image obtaining device (11) takes the image can be changed.

### Advantageous Effects of Invention

The present invention can make an air jetting orifice follow a mounted image taking part even if the position of the image taking part is changed, to make it possible to obtain a clear image.

### BRIEF DESCRIPTION OF DRAWINGS

FIG. 1 schematically shows structure of a dental handpiece system 100.

FIG. 2 shows an enlarged peripheral portion of a head 2 in FIG. 1.

FIG. 3 is a plan view around the head.

FIG. 4A is an explanatory plan view of structure of a light entry and outgo means, and FIG. 4B is an explanatory cross-sectional view of the structure of the light entry and outgo means.

FIG. 5 is an explanatory cross-sectional view of a trunk connector 41.

### DESCRIPTION OF EMBODIMENTS

The present invention will be described below based on the embodiment shown in the drawings. The present invention is not restricted to this embodiment.

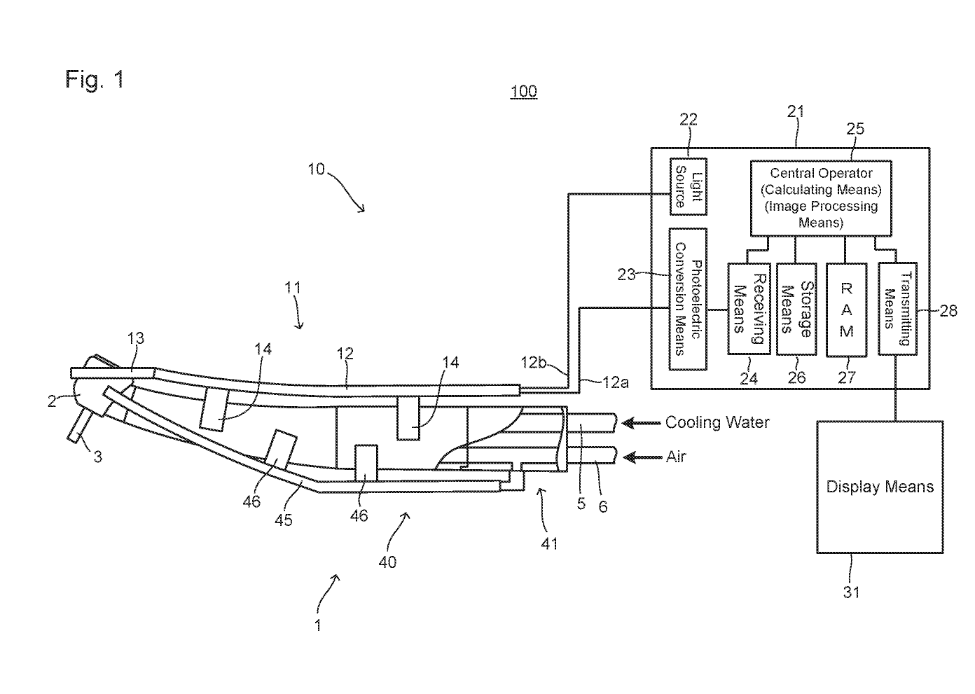

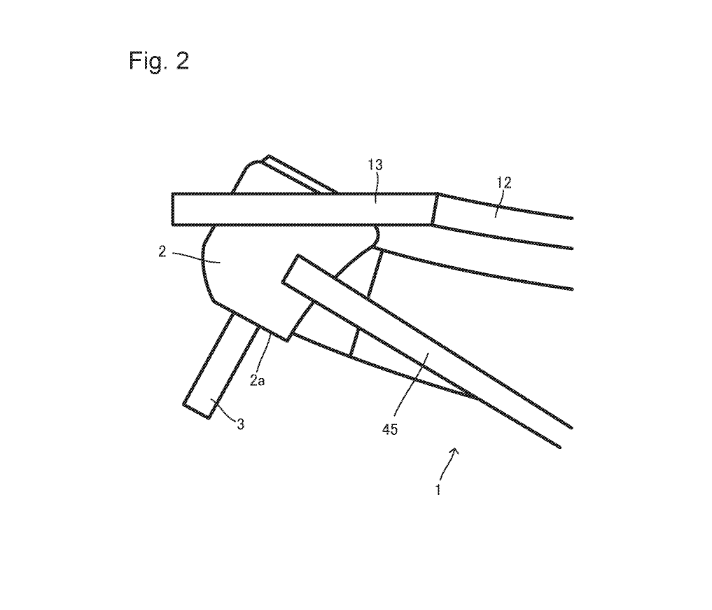

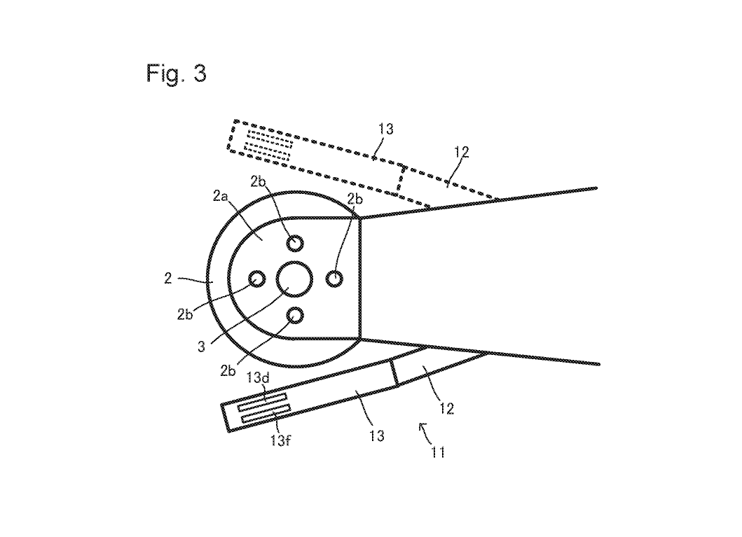

FIG. 1 is an explanatory view of one embodiment, which schematically shows the structure of a dental handpiece system 100. FIG. 2 is an enlarged view around a head 2 of a dental handpiece main body 1, and FIG. 3 is an enlarged view around the head 2 of the dental handpiece main body 1, which is an explanatory view of an image obtaining device 11 on the side where a tool 3 is mounted.

The dental handpiece system 100 has structure including the dental handpiece main body 1, an imaging device for a dental handpiece 10, and an air injection device 40.

In this embodiment, a known one can be used as the dental handpiece main body 1. That is, the head 2 is included, and a tool mounted part is provided for a tool mounted face 2a that is one face of the head 2. The tool 3 such as a dental drill is mounted on the tool mounted part. The tool 3 is given a turning force by blowing air supplied from an air pipe 6 that is connected to the dental handpiece main body 1 via a trunk connector 41, which is described later, into a passage provided inside the dental handpiece main body 1. Further, an air injection orifice where air is injected into the tool 3 may be also provided for the head 2 of the handpiece main body 1, which is omitted to be shown, and air injected therefrom may be supplied from the air pipe 6. Air injected for turning the tool and air injected into the tool as described above are part of air branched by the trunk connector 41 as described later.

As shown in FIG. 3, the tool mounted face 2a of the head 2 includes four cooling water ejecting orifices 2b. Passing cooling water supplied from a cooling water pipe 5 that is connected to the dental handpiece main body 1 via the trunk connector 41 through a passage that is provided inside the dental handpiece main body 1 results in ejection of the cooling water from the cooling water ejecting orifices 2b.

While the embodiment of the dental handpiece main body 1 is given here as one example, the present invention is not limited to this as described above, and a known dental handpiece main body can be applied.

The imaging device for a dental handpiece 10 includes the image obtaining device 11, a processing means 21, and a display means 31.

In this embodiment, the image obtaining device 11 has structure including a light guiding means 12, a light entry and outgo means 13, and retention members 14.

The light guiding means 12 is a member in the form of a cable which is made in such a way that light is guided to its inside. At least two light guiding paths are formed inside the light guiding means 12; that is, a light guiding path for an image 12a and a light guiding path for source light 12b. A specific form of guiding light for forming the light guiding path for an image 12a and the light guiding path for source light 12b is not limited, and is, for example, optical fiber.

Here, preferably, the light guiding means 12 has flexibility, and can keep its posture at a predetermined position. Whereby, the image obtaining device 11 can be deformed in a desired posture, and this posture can be kept.

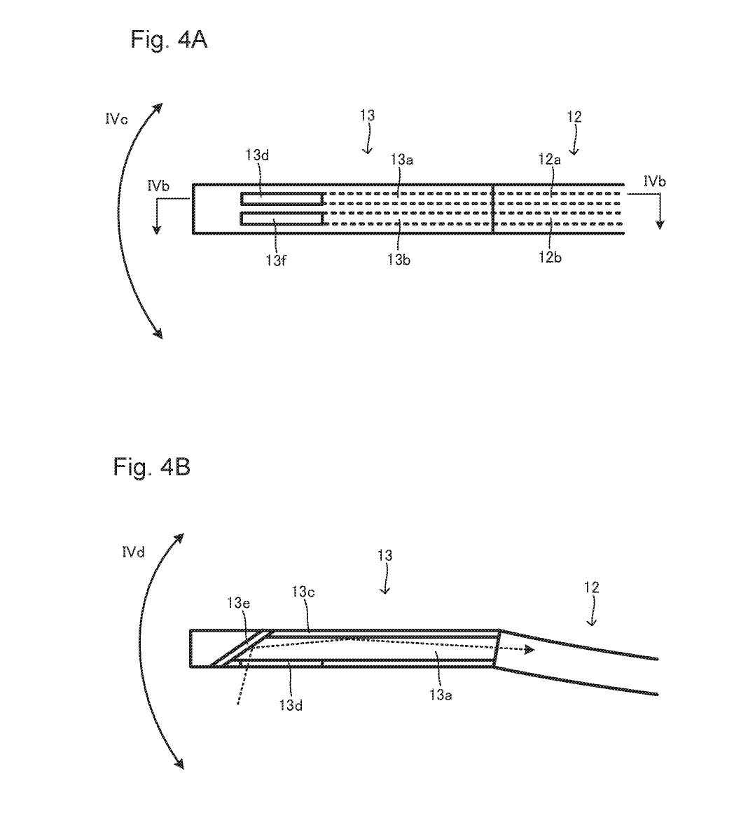

The light entry and outgo means 13 is arranged at one tip of the light guiding means 12 as can be seen from FIGS. 1 and 2. FIGS. 4A and 4B are views focused on the periphery of the light entry and outgo means 13 of the image obtaining device 11. FIG. 4A is a view of the light entry and outgo means 13 seen from the tool 3 side of FIG. 1 (that is, a view seen from the same viewpoint as FIG. 3), and FIG. 4B shows a cross section along the line IVb-IVb shown in FIG. 4A at the same viewpoint as FIG. 1.

As can be seen from FIG. 4A, the light entry and outgo means 13 has a light entry part 13a and a source light outgo part 13b, in its inside.

The light entry part 13a has a function of entering light from the inside of an oral cavity, obtaining an image to be photographed, and guiding the light to the light guiding path for an image 12a of the light guiding means 12. Therefore, the light entry part 13a is made so as to communicate with the light guiding path for an image 12a.

On the other hand, the source light outgo part 13b has a function of receiving source light from the light guiding path for source light 12b of the light guiding means 12, and letting this received light outgo as intraoral illumination light. Therefore, the source light outgo part 13b is made so as to communicate with the light guiding path for source light 12b.

In order to form the light entry part 13a and the source light outgo part 13b as described above, the light entry and outgo means 13 has the following structure in this embodiment.

As can be seen from FIG. 4B, the light entry and outgo means 13 has a peripheral wall part 13c around the light entry part 13a. The peripheral wall part 13c is a member in the form of a pipe, the inside of which forms the light entry part 13a, into which light from the inside of an oral cavity enters. Thus, the inner face of the peripheral wall part 13c is preferably a surface of a high light reflectivity. For example, the peripheral wall part 13c is made of metal, and its inner face is made to be a mirror surface.

The peripheral wall part 13c is partially notched to form an inlet 13d. The inlet 13d is a portion through which light is transmitted so that light from the inside of an oral cavity can be obtained inside the peripheral wall part 13c which is in the form of a pipe. Therefore, in addition to just opening holes, translucent glass or resin may be arranged here.

The peripheral wall part 13c is equipped with a reflecting member 13e on the opposite side of the side where the light guiding means 12 is connected. The reflecting member 13e is made of a member of a high light reflectivity. As can be seen from FIG. 4B, the reflecting member 13e has an inclined face for reflecting incident light from the inlet 13d so that the incident light approaches the light guiding direction. The reflecting member 13e is not specifically restricted as long as made of material of a high light reflectivity. The reflecting member 13e may be made of metal to utilize a mirror face, or may be made of resin to utilize total reflection due to refractive index difference from air.

The source light outgo part 13b has the same structure as the light entry part 13a, illustration and detailed description of which are omitted. That is, the source light outgo part 13b has structure including a peripheral wall part that includes the same structures as the peripheral wall part 13c, the inlet 13d, etc., a source light outlet 13f, and a reflecting member.

The retention members 14 are members provided so as to protrude from the light guiding means 12 as can be seen from FIG. 1. The retention members 14 are means that make it possible to attach the light guiding means 12 and the light entry and outgo means 13 to the dental handpiece main body 1, to retain them. A specific form of the retention members 14 is not limited as long as making such retention possible. Examples thereof include one having such a structure that the dental handpiece main body 1 is sandwiched, and one having such a structure as to adsorb the dental handpiece main body 1.

Here, the retention members have only to make it possible to retain the light entry and outgo means in the dental handpiece main body. Therefore, the retention members may be provided for the light entry and outgo means.

The number of the retention members 14 is not specifically limited as well. In this embodiment, the number is two. One retention member may be included, or no less than 3 retention members may be included.

The image obtaining device 11 as described above is attached to and retained in the dental handpiece main body 1 as follows: that is, as can be seen from FIGS. 1 to 3, the retention members 14 are attached to the dental handpiece main body 1. At this time, the inlet 13d of the light entry and outgo means 13 is arranged so as to face the tool 3 side.

Arrangement of the inlet 13d as described above makes it possible to obtain an image of a state while teeth or the like are drilled with the tool 3.

As described above, when the light guiding means 12 is formed of one having flexibility, it is possible to move the light entry and outgo means 13 as shown by the arrow IVc in FIG. 4A and the arrow IVd in FIG. 4B, to keep its posture in the moved state. Therefore, for example, as the light entry and outgo means 13 shown by the dashed line in FIG. 3, the light entry and outgo means 13 can be moved from the position shown by the solid line to another position, which makes it possible to properly correspond to a portion desired to be photographed at a desired angle.

Returning to FIG. 1, other components of the imaging device for a dental handpiece 10 will be described.

The processing means 21 is a means of supplying source light to the image obtaining device 11, and of processing the obtained light. Therefore, the processing means 21 has structure including a light source 22, a photoelectric conversion means 23, a receiving means 24, a central operator 25, a storage means 26, a RAM 27, and a transmitting means 28.

The light source 22 is a light source that supplies light provided for intraoral illumination. Therefore, white light is preferable. The light source is not specifically restricted, and is preferably a light emitting diode (LED) in view of a lifetime and energy conservation.

As can be seen from FIG. 1, the light source 22 is connected to the light guiding path for source light 12b of the light guiding means 12.

The photoelectric conversion means 23 is a means of converting input light to an electrical signal. A specific form thereof is not restricted as long as such a means is offered. Examples thereof include a CCD and a CMOS. Thus, as can be seen from FIG. 1, the photoelectric conversion means 23 is connected to the light guiding path for an image 12a of the light guiding means 12, to convert light guided here to an electrical signal.

The receiving means 24 is a member having a function of taking in an electrical signal from the photoelectric conversion means 23 which is based on light from the inside of an oral cavity. The receiving means 24 is connected to the photoelectric conversion means 23. What is called an input port, an input connector, etc. are included therein. The manner of the connection is not limited, and may be either wired or wireless connection.

The central operator 25 is what is called a CPU, and functions as an image processing means and other various calculating means. That is, the central operator 25 carries out various programs stored in the storage means 26 that functions as a storage medium, and calculates and outputs results thereof.

When functioning as an image processing means, the central operator 25 takes in an electrical signal from the receiving means 24, calculates based on programs, and as a result, generates an image signal. At this time, such an iconic effect can be also given if necessary as partially enlarging an image, displaying an image so as to highlight part of the image, and measuring on a screen, in addition to displaying a received signal as it is as an image. Whereby, convenience for a practitioner is improved. Known one can be applied as a program for such image processing.

The central operator 25 is connected to other members provided for the processing means 21 such as the receiving means 24, the storage means 26, the RAM 27, and the transmitting means 28, and is made so as to control them based on programs.

The storage means 26 is a member that functions as a storage medium where various programs and data that are the bases of the calculations carried out in the central operator 25 are stored. The storage means 26 may function as a storing means where data of images to be stored, patients' data, etc. are stored as well.

The RAM 27 is a member that functions as a work area for the calculations of the central operator 25, and a storage means for temporary data. The RAM 27 can be made of a SRAM, a DRAM, flash memory, or the like, which is the same as a known RAM.

The transmitting means 28 is a member having a function of transmitting a signal of the obtained results which is to be transmitted to the display means 31. What is called an output port, an output connector, etc. are included therein. The manner of the transmission is not limited, and may be either wired or wireless transmission.

The display means 31 is connected to the transmitting means 28 of the processing means 21, and is a means of displaying an image based on information obtained from the transmitting means 28. Any monitor or the like can be used as the display means 31.

Here, one embodiment of the imaging device for a dental handpiece 10 has been described. A specific embodiment of the imaging device for a dental handpiece is not restricted to this, and ones of other embodiments can be also applied as long as being able to be formed so as to bring about the effect of the present invention.

An example thereof is one including a photoelectric conversion means in the image obtaining device 11, and transmitting a converted electric signal to the receiving means 24 via an electric signal transmitting means such as a conductive wire instead of the light guiding means 12.

Another example thereof is one that can have structure of utilizing a built-in illumination light in a handpiece as a light source to take in reflection light from the inside of an oral cavity, and obtaining an image.

The air injection device 40 is a device of injecting air into a range where the image obtaining device 11 of the imaging device for a dental handpiece 10 takes an image, to solve poor visibility due to cooling water and swarf.

Therefore, the air injection device 40 has structure including the trunk connector 41, an air guiding pipe 45, and retention members 46.

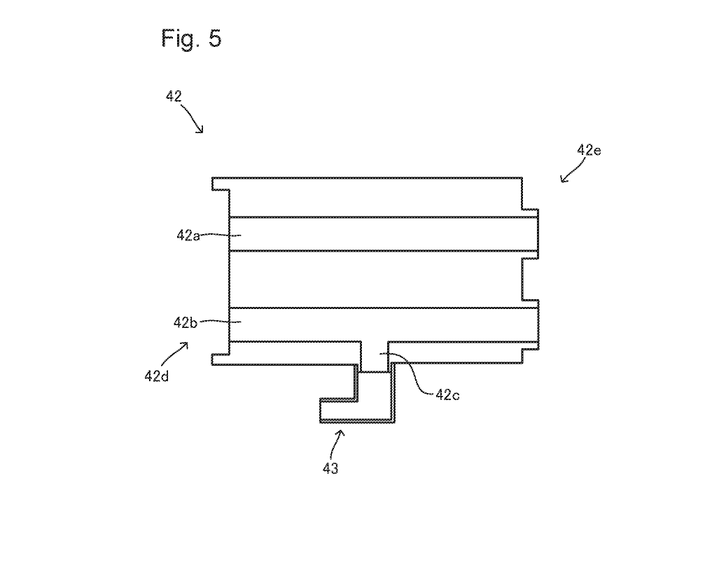

The trunk connector 41 is a columnar member in which a passage is formed. The handpiece main body 1 is connected to one end of the trunk connector 41, and the cooling water pipe 5 that supplies cooling water and the air pipe 6 that supplies air are connected to the other end. The trunk connector 41 has a function of branching air. FIG. 5 shows a cross section of the trunk connector 41. As also shown in FIG. 5, the trunk connector 41 has structure including a main body 42 and a leading pipe 43.

The main body 42 is a columnar member, inside which a passage for cooling water 42a and a passage for air 42b that axially penetrate through the main body 42 in parallel are formed. The passage for air 42b has a branch passage 42c that opens in a side face of the main body 42.

An end part of the main body 42 on the side where the handpiece main body 1 is connected is a connection terminal 42d that has a form capable of connecting to the handpiece main body 1. At this time, the main body 42 is arranged so that the passage for cooling water provided for the handpiece main body 1 communicates with the passage for cooling water 42a of the main body 42, and so that the passage for air provided for the handpiece main body 1 communicates with the passage for air 42b of the main body 42.

Similarly, an end part of the main body 42 on the side where the cooling water pipe 5 and the air pipe 6 are connected is a connection terminal 42e that has a form capable of connecting to the cooling water pipe 5 and the air pipe 6. At this time, the cooling water pipe 5 is connected so as to communicate with the passage for cooling water 42a of the main body 42, and the air pipe 6 is connected so as to communicate with the passage for air 42b of the main body 42.

The side face of the main body 42 where the branch passage 42c opens has a form capable of connecting to and communicating with the leading pipe 43.

The leading pipe 43 is a member in the form of a pipe, links the branch passage 42c to the air guiding pipe 45, and leads air from the branch passage 42c to the air guiding pipe 45. One end of the leading pipe 43 is linked to the main body 42 as described above, and the other end is made so that the air guiding pipe 45 can be linked thereto.

In this embodiment, the leading pipe 43 is made of a bending pipe, but is not restricted to this.

The air guiding pipe 45 is a member in the form of a pipe which is made so that air led from the branch passage 42c passes therethrough. Therefore, an air passage is formed inside the air guiding pipe 45. One end of the air guiding pipe 45 is connected to the leading pipe 43, and the other end extends to a place in which air can be injected into the range where the image obtaining device 11 takes an image (for example, light entry and outgo means 13), and opens so that air can be injected.

Here, preferably, the air guiding pipe 45 has flexibility, and can keep its posture at a predetermined position. Whereby, the place where air is injected can be changed following the movement of the light entry and outgo means 13 of the image obtaining device 11.

As can be seen from FIG. 1, the retention members 46 are members provided in such a way as to protrude from the air guiding pipe 45, and are means that make it possible to attach the air guiding pipe 45 to the dental handpiece main body 1 to be retained. A specific form of the retention members 46 is not limited as long as making such retention possible. Examples thereof include one having such a structure that the dental handpiece main body 1 is sandwiched, and one having such a structure as to adsorb the dental handpiece main body 1.

The number of the retention members 46 is not specifically limited as well. In this embodiment, the number is two. One retention member may be included, or no less than 3 retention members may be included.

The air injection device 40 as described above is attached to and retained in the dental handpiece main body 1 as follows: that is, as can be seen from FIG. 1, the connection terminal 42d of the main body 42 on the handpiece main body 1 side is connected to the end part of the handpiece main body 1 on the opposite side of the head 2, and the cooling water pipe 5 and the air pipe 6 are connected to the connection terminal 42e side.

In addition, the retention members 46 are attached to the dental handpiece main body 1. At this time, an air jetting orifice of the air guiding pipe 45 is arranged so as to face the inside of the range where an image is taken (for example, the inlet 13d of the light entry and outgo means 13).

Arrangement of the air guiding pipe 45 as described above makes it possible to blow away sprayed cooling water and swirling swarf to secure a field of vision even while teeth or the like are drilled with the tool 3, which makes it possible to obtain a clear image of a state of a drilled portion.

As described above, when the light guiding means 12 is formed of one having flexibility, it is possible to move the light entry and outgo means 13 as shown by the arrow IVc in FIG. 4A and the arrow IVd in FIG. 4B, to keep its posture in the moved state. Therefore, for example, as the light entry and outgo means 13 shown by the dashed line in FIG. 3, the light entry and outgo means 13 can be moved from the position shown by the solid line to another position.

Since the air guiding pipe 45 is made so as to be movable as well, a field of vision can be properly secured in any case if the air guiding pipe 45 is moved following the movement of the light entry and outgo means 13.

In the air injection device 40 in this embodiment, for turning the tool, injected air is used and/or air injected from the head is branched to be used. Thus, another air supply means is unnecessary to be provided. Further, since the trunk connector 41 branches air, the air injection device 40 can be attached in such a way as to be inserted into an existing dental handpiece, and can be custom-installed, which is highly convenience. Maintenance is also easy because the air injection device 40 can be attachable and detachable.

According to the dental handpiece system 100 including the above described structure, teeth or the like can be drilled as follows.

Blowing air into the dental handpiece main body 1 turns the mounted tool 3, and at the same time passing cooling water therethrough results in ejection of the cooling water from the cooling water ejecting orifices 2b. Whereby, teeth or the like can be drilled as usual while cooled. The blown air at this time branches at the trunk connector 41, and part of the air is injected into the light entry and outgo means 13.

In this embodiment, the light source 22 of the processing means 21 is lit. Whereby, light is emitted from the light source 22. The light is guided to the image obtaining device 11 connected to the light source 22, and outgoes from the source light outlet 13f, to illuminate the inside of an oral cavity. In detail, light emitted from the light source 22 is guided along the light guiding path for source light 12b, reaches the source light outgo part 13b provided for the light entry and outgo means 13, is reflected on the reflecting member, and outgoes from the source light outlet 13f.

Illuminating the inside of an oral cavity as described above makes it possible to obtain an intraoral image. That is, reflected light from the illuminated inside of an oral cavity enters into the light entry part 13a from the inlet 13d of the light entry and outgo means 13 as shown by the dashed arrow in FIG. 4B, reflects on the reflecting member 13e, and enters into the light guiding path for an image 12a of the light guiding means 12. The light from the inside of an oral cavity is guided along the light guiding path for an image 12a, and an image is generated by the processing means 21 and is displayed on the display means 31.

As described above, according to the imaging device for a dental handpiece 10, drilling can be performed while condition of teeth or the like drilled with the tool 3 is visually perceived with the display means 31 by attaching the image obtaining device 11 to the dental handpiece main body 1 to make the dental handpiece. Here, since air is injected into the range where an image is obtained by the air injection device 40, poor visibility due to influence of cooling water and swarf can be mostly prevented, and a clear image of a drilled portion can be obtained even when cooling water is used.

When the light guiding means 12 has flexibility, the position of the inlet 13d can be properly changed, which can result in obtainment of a clearer image, and flexibility toward treatment. Similarly, since the air guiding pipe 45 of the air injection device 40 can be moved, the air guiding pipe 45 can be movable following the movement of the inlet 13d.

In addition to this, if an image is enlarged by the processing means 21 or the like to display the image that is easier to be observed, not only a clear image but also details and a portion that has been in a blind spot so as not to have been visually perceived can be seen, which can improve the precision of the performance and easiness of operation.

In this embodiment, the example of including one light entry and outgo means 13 is described. Without being limited to this, embodiments of the present invention may include one including no less than two light entry and outgo means arranged at a different position. Along this, the number of the air guiding pipes 45 of the air injection device 40 is changed or the air guiding pipe 45 is branched in the middle, to make a plurality of the injection orifices, which brings about the same effect as described above.

According to this, the numbers of the light guiding paths for an image and the light guiding paths for source light have to increase according to the number of the light entry and outgo means. However, it is possible to visually perceive teeth at more angles.

### REFERENCE SIGNS LIST

1 dental handpiece main body

2 head

2a tool mounted face

2b cooling water ejecting orifices

3 tool

5 cooling water pipe

6 air pipe

10 imaging device for a dental handpiece

11 image obtaining device

12 light guiding means

13 light entry and outgo means

13a light entry part

13b source light outgo part

13c peripheral wall part

13d inlet

13e reflecting member

13f source light outlet

14 retention members

21 processing means

22 light source

23 photoelectric conversion means

24 receiving means

25 central operator

26 storage means

27 RAM

28 transmitting means

31 display means

40 air injection device

41 trunk connector

42 main body

43 leading pipe

45 air guiding pipe

46 retention members

100 dental handpiece system

1. An air injection device that is provided for a dental handpiece main body, the air injection device comprising:
a trunk connector that is in a form of a column, in the trunk connector a passage being formed;
an air guiding pipe that is in a form of a pipe, one end of the air guiding pipe being connected to the trunk connector, the air guiding pipe having flexibility; and
a means that retains the air guiding pipe in the dental handpiece main body,
wherein the passage in the trunk connector branches, one of the branching passages communicating with the air guiding pipe.

2. A dental handpiece system comprising:
a dental handpiece main body;
an image obtaining device that is capable of taking an image of a drilling part of a tool that is provided for the dental handpiece main body; and
the air injection device according to claim 1.

3. The dental handpiece system according to claim 2, wherein
the air guiding pipe is disposed in such a way as to inject air into a range where the image obtaining device takes the image.

4. The dental handpiece system according to claim 2, a position where the image obtaining device takes the image can be changed.
